(19) United States
(12) Patent Application Publication
(10) Pub. No.: US 2009/0059260 A1
(43) Pub. Date: Mar. 5, 2009

(54) MULTIFUNCTION PERIPHERAL

(75) Inventor: Tetsuro Matsuno, Niwa-gun (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 12/194,967

(22) Filed: Aug. 20, 2008

(30) Foreign Application Priority Data
Aug. 31, 2007 (JP) 2007-225262

(51) Int. Cl. G06F 3/12; H04M 11/00

(52) U.S. Cl. 358/1.13; 379/100.01

(57) ABSTRACT

There is provided a multifunction peripheral having a plurality of functions, including: a phone communication unit having a phone communication function; a communication interface to interface the multifunction peripheral with an external device; a processing unit to control operations of the multifunction peripheral; a judgment unit to judge whether external data received through the communication interface corresponds to data of a first predetermined type; and a conversion unit having a function of converting, without controls by the processing unit, the external data into data of a second predetermined type adapted to the phone communication function in response to a fact that the judgment unit judges that the external data corresponds to data of the first predetermined type, and having a function of converting, without controls by the processing unit, data of the second predetermined type into data of the first predetermined type to be outputted through the communication interface.

### CROSS-REFERENCE TO RELATED APPLICATION

This application claims priority under 35 U.S.C. §119 from Japanese Patent Application No. 2007-225262, filed on Aug. 31, 2007. The entire subject matter of the application is incorporated herein by reference.

### BACKGROUND

1. Technical Field

Aspects of the present invention relate to a multifunction peripheral having multiple functions, such as a phone communication function and a copying function.

2. Related Art

USB telephone systems in which a telephone and a PC (personal computer) are connected to each other via a USB cable have been proposed. In this system, telephone communication with a part at the end of an external network is achieved. Japanese Patent Provisional Publication No. 2003-169160 (hereafter, referred to as JP 2003-169160) discloses an example of such a USB telephone system. In the system disclosed in JP 2003-169160,

In the USB telephone system disclosed in JP 2003-169160, processing for analog signals is executed on the telephone and high level digital signal processing is executed on the PC so that various functions including management on the phone numbers, saving of history data concerning incoming calls, and sound recordation can be achieved.

### SUMMARY

Although the above described function of the USB telephone system is able to achieve the various functions (e.g., the management on the phone numbers, saving of history data concerning incoming calls, sound recordation), a processing unit in the USB telephone system is occupied when one of the functions is executed. That is, the processing unit in the USB telephone system is occupied due to execution of one of the above described functions and data communication with the PC.

Recently, multifunction peripherals having multiple functions including a scanner function for reading a document, a copying function for forming an image read from a document, and a facsimile function for receiving facsimile data from an external network have been proposed. Considering the case where a user starts internet phone communication on a multifunction peripheral to which a PC is connected to from a telephone system while the multifunction peripheral executes the copying function, data communication between the multifunction peripheral and the PC may be delayed due to the fact that a processing unit of the multifunction peripheral is occupied to execute the copying function.

As a result, the internet phone communication executed on the multifunction peripheral may become unstable. In this case, delay or interruptions of sound output may be caused in the internet phone communication.

Aspects of the present invention are advantageous in that a multifunction peripheral capable of executing concurrently functions of the multifunction peripheral and phone communication through the Internet without trouble is provided.

According to an aspect of the invention, there is provided a multifunction peripheral having a plurality of functions, comprising: a phone communication unit having a phone communication function; a communication interface configured to interface the multifunction peripheral with an external device; a processing unit configured to control operations of the multifunction peripheral; a judgment unit configured to judge whether external data received through the communication interface corresponds to data of a first predetermined type; and a conversion unit having a function of converting, without controls by the processing unit, the external data into data of a second predetermined type adapted to the phone communication function of the phone communication unit in response to a fact that the judgment unit judges that the external data corresponds to data of the first predetermined type, and having a function of converting, without controls by the processing unit, data of the second predetermined type into data of the first predetermined type to be outputted through the communication interface.

With this configuration, it becomes possible to execute the internet phone communication without controls by the processing unit. Therefore, even if the processing unit is occupied by execution of one or more of the plurality of functions of the multifunction peripheral, it is possible to prevent the unstable state from occurring in the internet phone communication. It is possible to execute concurrently functions of the multifunction peripheral and the internet phone communication without trouble.

It is noted that various connections are set forth between elements in the following description. It is noted that these connections in general and unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

### BRIEF DESCRIPTION OF THE ACCOMPANYING DRAWINGS

FIG. 1 is a block diagram of a multifunction peripheral according to an embodiment.

FIG. 2 illustrates a block diagram of a communication controller and its related components used in an MFP particularly for an internet phone communication.

FIG. 3 is a state transition diagram illustrating state transition concerning data passing from a handset to the Internet.

FIG. 4 is a state transition diagram illustrating state transition concerning data passing from the Internet to the handset.

### DETAILED DESCRIPTION

Hereafter, an embodiment according to the invention will be described with reference to the accompanying drawings.

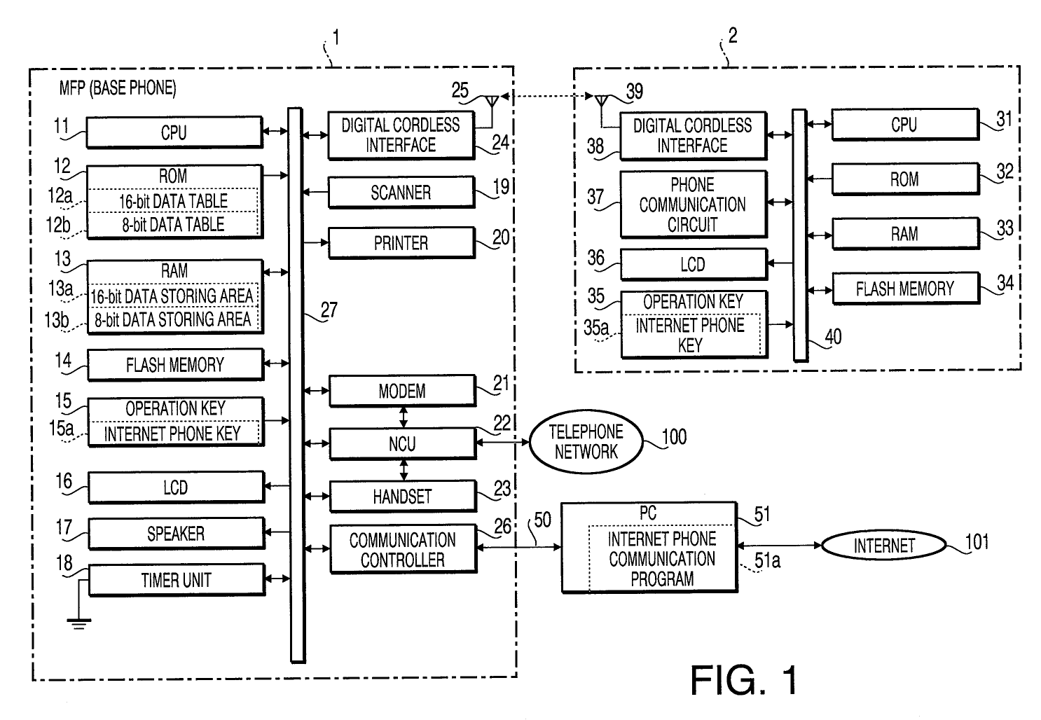

FIG. 1 is a block diagram of a multifunction peripheral according to an embodiment. The MFP 1 has multiple functions including a phone communication function, a facsimile function, a printing function, a scanner function and a copying function. Regarding the phone communication function, the MFP 1 has a function of performing phone communication through a telephone network and a function of performing phone communication through Internet 101.

The MFP 1 has a function of communicating with a cordless handset 2 through a wireless signal. That is, the MFP 1 serves as a base phone for the cordless handset. In this configuration, the MFP 1 allows a user to selectively use one of the cordless handset 2 and a handset 23. The MFP 1 also provides an internal line for phone communication between the handset 23 and the cordless handset 2.

As shown in FIG. 1, the MFP 1 includes a CPU 11, a ROM 12, a RAM 13, a flash memory 14, operation keys 15, an LCD (Liquid Crystal Display) unit 16, a speaker 17, a timer unit 18, a scanner unit 19, a printing unit 20, a modem 21, an NCU (Network Control Unit) 22, the handset 23, a digital cordless interface 24 to which an antenna 25 is connected, and a communication controller 26, which are connected to each other via a bus 27.

The CPU 11 controls various internal units connected thereto via the bus 27 in accordance with fixed values and programs stored in the ROM 12 or the flash memory 14, various signals received through the digital cordless interface 24, or various signals received through the communication controller 26.

The ROM 12 sores various fixed values and programs to be executed on the MFP 1. Further, the ROM 12 includes a 16-bit data table 12a and an 8-bit data table 12b. The 16-bit data table stores 16-bit PCM data associated with 8-bit PCM data, and the 8-bit data table 8-bit PCM data associated with the 16-bit PCM data.

The RAM 13 temporarily stores various types of data. The RAM 13 includes a 16-bit data storing area 13a and a 8-bit data storing area 13b.

When the MFP 1 is turned to ON (or when the Internet phone communication is started), the 16-bit PCM data associated with the 8-bit PCM data is loaded from the 16-bit data table 12a onto the 16-bit data storing area 13a, and the 8-bit PCM data associated with the 16-bit PCM data is loaded from the 8-bit data table 12b onto the 8-bit data storing area 13b.

The flash memory 14 stores various types of data. The data stored in the flash memory 14 is maintained in the flash memory 14 during a power-off state of the MFP 1.

The operation keys 15 are provided on an operation panel (not shown), and include numeric keys, a start button, and function buttons. The user is able to input various commands (e.g., a command for turning ON or OFF the MFP 1 or a command for switching between various functions of the MFP 1) through the operation keys 15.

The operation keys 15 include an Internet phone key 15a which is used by the user to start the Internet phone communication. When the Internet phone key 15a is operated, the communication controller 26 executes data conversion between the 8-bit PCM data and the 16-bit PCM data.

The LCD 16 is provided on the operation panel (not shown). On the LCD 16, various types of information including menus formed depending on the operation of the operation keys 15 and statuses of the MFP 1 are displayed. Further, on the LCD 16, an image obtained through the scanner function or image data for printing transmitted from an external computer (PC 51) is displayed.

Through the speaker 17, various types of sounds (e.g., operating sounds of the operation keys 15, a beeping sound indicating an error, or a calling sound indicating an incoming call) are produced. The MFP 1 indicates various statuses of the MFP 1 through the sounds produced by the speaker 17.

The timer unit 18 includes an internal timer providing data and time information. The timer unit 18 has a function obtaining an elapsed time between a start time and a current time.

The scanner unit 19 reads an image from a document placed on a document base (not shown) in accordance with instructions from the CPU 11. The image data obtained by the scanner unit 19 is stored in a predetermined area in the RAM 13 when the MFP I is set to a facsimile mode, a scanner mode, or a copying mode.

The printing unit 20 has a function of printing an image on a sheet f paper supplied from a sheet supply tray (not shown) in accordance with instructions from the CPU 21. For example, the printing unit 20 prints an image corresponding to the image data stored in the predetermined area in the RAM 13 in one of the facsimile mode, the scanner mode and the copying mode. Further, the printing unit 20 is able to print an image corresponding to image data transmitted from the PC 51. In this embodiment, the printing unit 20 is formed as an inkjet printer which employs an inkjet printing process in which ink is ejected selectively from nozzles onto a recording medium.

The modem 21 modulates transmission data stored in the RAM 13 to form an image signal to be transmitted to the telephone network 100, and transmits the image signal to the telephone network 100 via the NCU 22. Further, the modem 21 receives, via the NCU 22, an image signal transmitted from the telephone network 100, and demodulates the received image signal to obtain image data to be displayed on the LCD 16 or image data to be printed through the printing unit 20.

The NCU 22 executes various control, such as control for transmitting a dialing signal to the telephone network 100 and responding to a call signal from the telephone network 100.

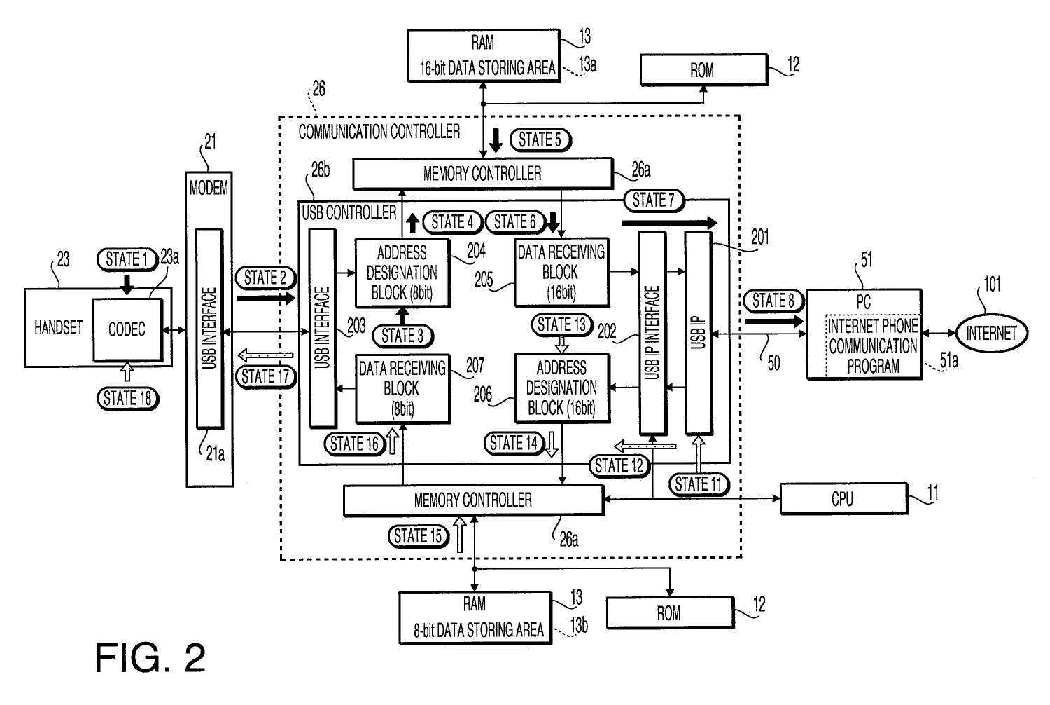

The handset 23 is used to perform the phone communication with the cordless handset 2 or a party of the other end of the telephone network 100 or the Internet 101. More specifically, the handset 23 includes a CODEC 23a configured to convert an analog signal (sound data) into a digital signal (phone communication data) and to convert a digital signal into an analog signal (see FIG. 2). The handset 23 further includes a speaker (not shown) through which sound is outputted. That is, the handset 23 has a function as a sound interface.

When the handset 23 is detached from the MFP 1 by the user (i.e., when the handset 23 moves to an off-hook state), the handset 23 is electrically connected to the NCU 22 or the digital cordless interface 26. When the handset 23 is put on the MFP 1 (i.e., when the handset 23 moves to an on-hook state), the electrical connection between the handset 23 and the NCU 22 (or the digital cordless interface 24) is released.

When the Internet phone key 15a is operated in the state where the handset 23 has moved to the off-hook state, the handset 23 is electrically connected to the communication controller 26. On the other hand, when the handset 23 is moved to the on-hook state, the electrical connection between the handset 23 and the communication controller 26 is released.

To the digital cordless interface 24, the antennal 25 for wireless communication with the cordless handset 2 is connected. For example, when the connection between the handset 23 and the digital cordless interface 24 is established in response to transition of the handset 23 to the off-hook state, the MFP 1 and the cordless handset 2 is connected to each other via wireless communication.

When receiving sound data from the handset 23, the digital cordless interface 24 converts the sound data into digital signal for wireless communication, and transmits the digital data to the cordless handset 2. On the other hand, when receiving digital signal from the cordless handset 2, the digital cordless interface 24 converts the received digital signal into sound data, and passes the sound data to the handset 23.

The communication controller 26 is connected to the PC 51 via a USB cable 50. The MFP 1 is able to communicate with the PC 51 via the communication controller 26. More specifically, the communication controller 26 has a function of converting the 16-bit PCM data transmitted from the PC 51 into the 8-bit PCM data and a function of converting the 8-bit PCM data into the 16-bit PCM data. In other words, the communication controller 26 has a function of converting the 16 bit PCM data used on the Internet 101 for the internet phone communication into the 8 bit PCM data used in the MFP 1 and a function of the 8-bit PCM data used in the MFP 1 into the 16-bit PCM data to be used on the Internet 101 for the internet phone communication.

When the communication controller 26 receives image data to be subjected to a printing operation through the printing unit 20, the communication controller 26 informs the CPU 21 of reception of the mage data and stores the image data in the RAM 13.

The PC 51 is connected to the Internet 101, and is able to communicate with an external computer via the Internet 101. In the PC 51, an internet phone communication program 51a is stored. By executing the internet phone communication program 51a, the PC 51 achieves a function of converting data into data having a predetermined format adapted for the internet phone communication.

Hereafter, the cordless handset 2 is explained. The cordless handset 2 includes a CPU 31, a ROM 32, a RAM 33, a flash memory 34, operation keys 35, an LCD 36, a phone communication circuit 37, and a digital cordless interface 38, which are connected to each other via a bus 40.

The CPU 31 controls various internal components in the cordless handset 2 in accordance with programs and fixed values stored in the ROM 32 or the flash memory 34. The CPU 31 is also able to controls the various internal components in accordance with various signals transmitted or received through the digital cordless interface 38.

The ROM 32 stores fixed values and programs to be executed on the cordless handset 2. The RAM 32 stores temporarily various types of data. The flash memory 34 stores various types of data for executions of the functions of the cordless handset 2. The data in the flashmemory 34 is maintained in the power-off sate of the cordless handset 2.

The operation keys 35 include numeric keys (ten-key), a phone button and function buttons. The operation keys 35 are operated to set various function settings of the cordless handset 2, and to perform the phone communication via the telephone network 100. A Internet phone key 35a having the same function as the Internet phone key 15a is provided in the operation keys 35. With this configuration, the user is able to start the internet phone communication while operating the cordless handset 2.

On the LCD 36, various types of information to be indicated during the phone communication or during a standby state are displayed. For example, a telephone number of a party at the other end inputted through the operation keys 35 is displayed on the LCD 36.

The phone communication circuit 37 has a function of executing the phone communication with the MFP 1 (in private phone communication), a party at the other end of the telephone network 100, or a party at the other end of the Internet 101. To the phone communication circuit 37, a CODEC and a speaker (not shown) are connected.

When the operation keys 35 are operated to move the cordless handset 2 to the off-hook state, the phone communication circuit 37 is electrically connected to the digital cordless interface 38. On the other hand, when the operation keys 35 are operated to move the cordless handset 2 to the on-hook state, the electrical connection between the phone communication circuit 37 and the digital cordless interface 38 is released.

To the digital cordless interface 38, an antenna 39 for wireless communication is connected. When the cordless handset 2 moves to the off-hook state and the electrical connection between the phone communication circuit 37 and the digital cordless interface 38 us established, the wireless connection between the cordless handset 2 and the MFP 1 is established.

When receiving sound data from the phone communication circuit 37, the digital cordless interface 38 converts the sound data into a digital signal for wireless communication, and transmits the digital signal to the MFP 1. On the other hand, when the digital cordless circuit 38 receives a digital signal from the MFP 1, the digital cordless interface 38 converts the received digital signal into sound data, and passes the sound data to the phone communication circuit 37.

Operations of the communication controller 26 will now be explained with reference to FIG. 2. FIG. 2 illustrates a block diagram of the communication controller 26 and its related components used in the MFP 1 particularly for the internet phone communication.

As shown in FIG. 2, the communication controller 26 includes memory controllers 26a and a USB controller 26b as main parts. For example, the communication controller 26 is formed as an integrated circuit, such as an ASIC (Application Specific Integrated Circuit) or a gate array.

The communication controller 26 includes a USB IP (Intellectual Property) 201, a USB IP interface 202, a modem and USB interface 203, an address designation block (8 bit) 204, a data receiving block (16 bit) 205, an address designation block (16 bit) 206, and a data receiving block (8 bit) 207.

To the USB IP 201, the USB cable 50 is attached. The USB IP 201 has a function of receiving various types of data from the PC 51 through the USB cable 50, and a function of judging the type of data received from the PC 51. The USB IP interface 202 achieves data passing between the USB IP 201 and the data receiving block 205 or between the USB IP 201 and the data designation block 206.

The modem and USB interface 203 is connected to a modem and USB interface 21a provided in the modem 21. The communication controller 26 (i.e., the USB controller 26b) communicates with the modem 21 via the modem and USB interfaces 203 and 21a.

The address designation block 204 is connected to the modem and USB interface 203 and the memory controller 26a. The address designation block 204 has a function of designating an address in the RAM 13 corresponding to 8 bit PCM data received from the modem 21, and requesting the memory controller 26a to read data corresponding to the designated address. More specifically, the address designation block 204 obtains 16 bit PCM data corresponding to the 8 bit PCM data, obtains an address of the 16 bit data storing area 13a based on the obtained 16 bit PCM data and a first address of the 16 bit data storing area 13a.

The data receiving block 205 is connected to the memory controller 26a and the USB IP interface 202. The data receiving block 205 has a function of receiving the 16 bit PCM data read by the memory controller 26a, and pasing the received 16 bit PCM data to the USB IP 201 via the USB IP interface 202.

The address designation block 206 is connected to the USB IP interface 202 and the memory controller 26a. The address designation block 206 has a function of designating an address of the RAM 13 corresponding to 16 bit PCM data received from the USB IP 201, and requesting the memory controller 26a to read data corresponding to the designated address. More specifically, the address designation block 206 obtains 8 bit PCM data corresponding to 16 bit PCM data, and designates an address of the 8 bit data storing area 13b based on the 8 bit PCM data and a first address of the 8 bit data storing area 13b.

The data receiving block 207 is connected to the memory controller 26a and the modem and USB interface 203. The data receiving unit 207 has a function of receiving the 8 bit PCM data read by the memory controller 26a, and passing the received 8 bit PCM data to the modem 21 via the modem and USB interface 203.

As shown in FIG. 2, the handset 23 includes the CODEC 23a. The CODEC 23a has a function of converting sound data (an analog signal) representing voice of the user into 8 bit PCM data, and a function of converting 8 bit PCM data received from the modem 21 into sound data (an analog signal).

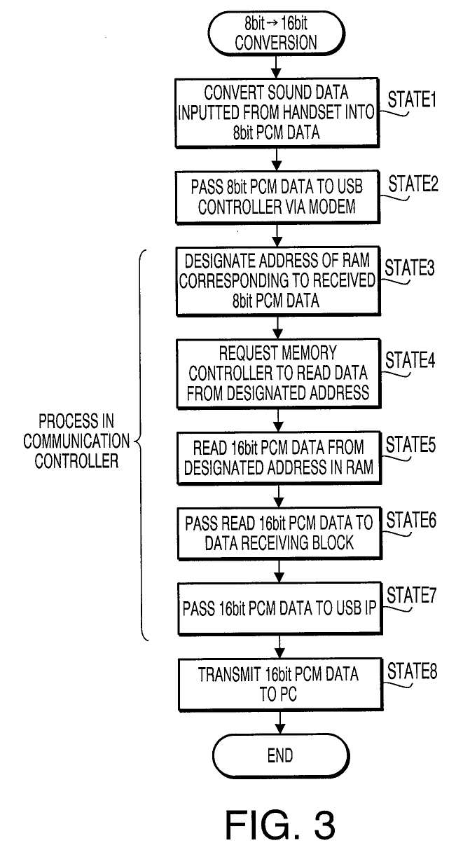

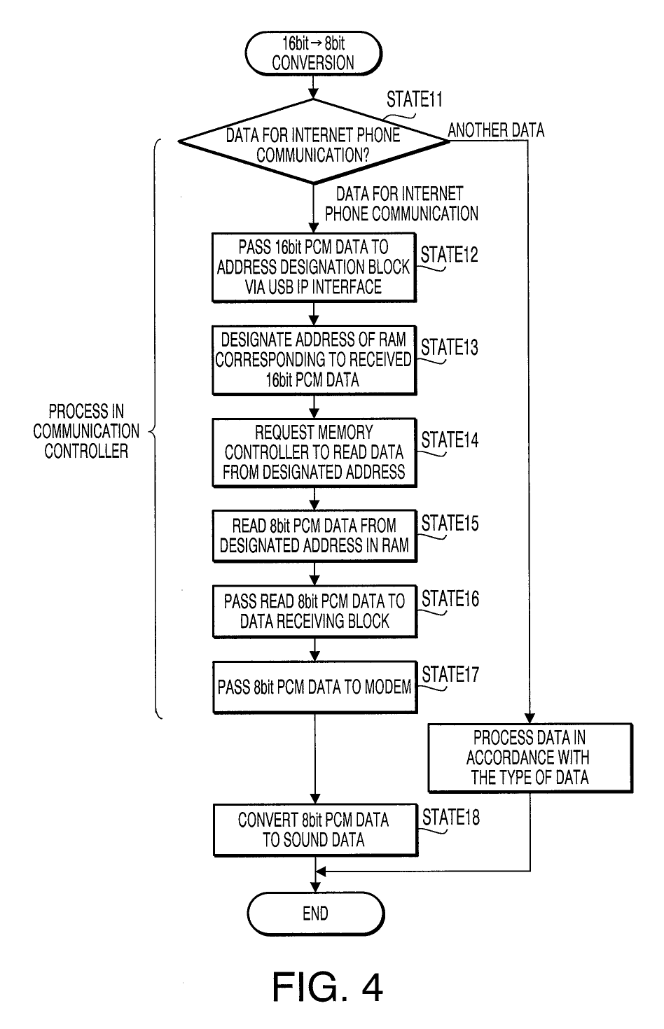

Hereafter, operations of the hardware components shown in FIGS. 1 and 2 and data flow concerning the internet phone communication are explained with reference to FIGS. 3 and 4. FIG. 3 is a state transition diagram illustrating state transition concerning the data passing from the handset 23 to the Internet 101. FIG. 4 is a state transition diagram illustrating state transition concerning the data passing the Internet 101 to the handset 23. The state numbers 1 to 18 shown in FIGS. 3 and 4 respectively correspond to state numbers 1-18 shown in FIG. 2.

In order to pass data from the handset 23 to the Internet 101, the user inputs the user's voice to the handset 23. That is, sound data (an analog signal) is inputted to the handset 23.

As shown in FIG. 3, when sound data is inputted to the handset 23, the sound data (the analog signal) is converted by the CODEC 23a into 8 bit PCM data (STATE 1). The 8 bit PCM data converted by the CODEC 23a is passed to the USB controller 26b of the communication controller 26 via the modem 21 (STATE 2).

The 8 bit PCM data received by the USB controller 26b is then passed to the address designation block 204. The address designation block 204 designates an address of the 16 bit data storing area 13a at which 16 bit PCM data corresponding to the passed 8 bit PCM data is stored (STATE 3). As described above, the address of the 16 bit data storing area 13a is obtained based on the 16 bit PCM data corresponding to the 8 bit PCM data and the first address of the 16 bit data storing area.

More specifically, the designated address is obtained as follows. First, the 8 bit PCM data is multiplied by a factor calculated according to a ratio between bit and 16 bit to obtain the 16 bit PCM data. Based on a temporary address corresponding to the obtained 16 bit PCM data and the first address (i.e., a real address) at which an initial value of 16 bit PCM data is stored, the designated address of the 16 bit PCM data is obtained.

Then, the address designation block 204 requests the memory controller 206 to read the 16 bit PCM data at the designated address (STATE 4). Next, the memory controller 26a reads the 16 bit PCM data from the designated address in the 16 bit data storing area 13a (STATE 5).

Then, the memory controller 26a passes the 16 bit PCM data read from the 16 bit data storing area 13a, to the data receiving block 205 (STATE 6). The data receiving block 205 passes the received 16 bit PCM data to the USB IP 201 via the USB IP interface 202 (STATE 7).

The USB IP 201 which received the 16 bit PCM data from the data receiving block 205 transmits the 16 bit PCM data to the PC 51 via the USB cable 50 (STATE 8). Thus, the data passing in the MFP 1 finishes. The STATES 3 to 7 correspond to data conversion in the communication controller 26. It is noted that since the data conversion from 8 bit PCM data to 16 bit PCM data perfume by the communication controller 26 corresponds to data conversion for adding data to original data.

The PC 51 creates data adapted to use in the internet phone communication by executing the internet phone communication program 51a, and transmits the created data to a party (an external computer) at the other end via the Internet 101.

Data passing from the Internet 101 to the handset 23 is performed as follows. As shown in FIG. 4, first the PC 51 receives data for the internet phone communication from a party at the other end of the Internet 101. Then, the PC 51 creates 16 bit PCM data adapted to processing on the MFP 1 by executing the internet phone communication program 51a, and transmits the created data to the USB IP 201 of the communication controller 26 via the USB cable 50.

Next, the USB IP 201 judges whether the received data is data used for the internet phone communication (STATE 11). For example, the USB IP 201 judges that the received data is data for the internet phone communication if the first byte of the received data is “1”, while the USB IP 201 judges that the received data is not the data for the internet phone communication if the first byte of the received data is “0”. In this case, the PC 51 assigns “1” to the first byte of the 16 bit PCM data created from the data for the internet phone communication.

If the received data is not data for the internet phone communication (STATE 11: “data for another purpose”), the received data is data to be used for another purpose (e.g., image data to be subjected to the printing operation). Therefore, in this case, the USB IP 201 informs the CPU 11 of the fact that the received data is data to be used for another purpose. Then, the CPU 11 processes the received data in accordance with the type of the received data. In this case, the USB IP 201 operates in accordance with instructions from the CPU 11.

If the USB IP 201 judges that the received data is data for the internet phone communication (STATE 11: “data for internet phone communication)), the USB IP 201 passes the received 16 bit PCM data to the address designation block 206 via the USB IP interface 202 (STATE 12).

The address designation unit 206 designates an address at which 8 bit PCM data corresponding to the received 16 bit PCM data is stored in the 8but data storing area 13b (STATE 13). It is noted that the designation of the address of the 8 bit data storing area 13b is achieved in accordance with substantially the same way as the above described designation of the address of the 16 bit data storing area 13a.

Then, the address designation unit 206 requests the memory controller 26a to read the 8 bit PCM data at the designated address in the 8 bit data storing area 13b (STATE 14). Then, the memory controller 26a reads the 8 bit PCM data from the designated address in the 8 bit data storing area 13b (STATE 15).

The memory controller 26a which has read the 8 bit PCM data passes the 8 bit PCM data to the data receiving block 207 (STATE 16). Then, the data receiving block 207 passes the received 8 bit PCM data to the modem 21 via the modem and USB interface 203 (STATE 17).

The STATES 12 to 17 in FIG. 4 correspond to data conversion in the communication controller 26. It is noted that the data conversion from 16 bit PCM data to 8 bit PCM data performed by the communication controller 26 corresponds to conversion for thinning out data.

The modem 21 which received the 8 bit PCM data from the data receiving block 207 passes the 8 bit PCM data to the CODEC 23a so that the 8 bit PCM data is converted by the CODEC 23a into sound data (an analog signal) (STATE 18). Thus, sound corresponding to the sound data is output from the speaker of the handset 23.

As described above, according to the embodiment, when the communication controller 26 receives data (e.g., image data) for different purposes from the phone communication, the communication controller 26 executes a receiving process for such data in accordance with instructions from the CPU 11. On the other hand, when the communication controller 26 receives the 16 bit PCM data for the internet phone communication from the PC 51, the communication controller 26 converts the 16 bit PCM data into the 8 bit PCM data without the need for processing by the CPU 11. That is, the communication controller 26 achieves the internet phone communication without controls by the CPU 11.

When the communication controller 26 receives the 8 bit PCM data from the handset 23 in the state where the Internet phone key 15a has been operated, the communication controller 26 converts the received 8 bit PCM data into 16 bit PCM data without the need for processing by the CPU 11. That is, the communication controller 26 achieves the internet phone communication without the need for processing by the CPU 11.

Since the internet phone communication is achieved without the need for processing by the CPU 11, it is possible to prevent an unstable state of the internet phone communication (e.g., delay or interruptions of sound output) from occurring when the MFP 1 executes another function (e.g., the copying function, the scanner function or the facsimile function) which may occupy processing performance of the CPU 11. That is, a multifunction peripheral capable of executing the internet phone communication and other functions concurrently without problems.

In the above described embodiment, the data conversion between 16 bit PCM data and 8 bit PCM data is performed by designating the address of the 16 bit data storing area 13a in which targeted 16 bit PCM data is stored or the 8 bit data storing area 13b in which targeted 8 bit PCM data is stored, and by reading the targeted data from the designated address. It is understood that according to the embodiment, the data conversion between 8 bit PCM data and 16 bit PCM data is achieved without the need for complicated circuit or processes. That is, the communication controller 26 does not need to have a complicated circuit to achieve the data conversion.

Although the present invention has been described in considerable detail with reference to certain preferred embodiments thereof, other embodiments are possible.

In the above described embodiment, the communication controller 26 is formed as an ASIC. However, the ASIC including the communication controller 26 may further include other circuits (e.g., the CPU 11, the ROM 12, the RAM 13 and the modem 21).

In the above described embodiment, the MFP 1 executes the data conversion between 8 bit PCM data and 16 bit PCM data to achieve the internet phone communication. However, data conversion between PCM data having a number of bits different from 8-bit and PCM data having a number of bits different from 16-bit may be performed in the MFP 1.

The data format used on the Internet 101 (i.e., the modulating way or the sampling frequency) is not limited to those described in the above described embodiment. If another data format is used, data corresponding to a different modulating way or a different sampling frequency may be used to achieve the phone communication.

What is claimed is:

1. A multifunction peripheral having a plurality of functions, comprising:
a phone communication unit having a phone communication function;
a communication interface configured to interface the multifunction peripheral with an external device;
a processing unit configured to control operations of the multifunction peripheral;
a judgment unit configured to judge whether external data received through the communication interface corresponds to data of a first predetermined type; and
a conversion unit having a function of converting, without controls by the processing unit, the external data into data of a second predetermined type adapted to the phone communication function of the phone communication unit in response to a fact that the judgment unit judges that the external data corresponds to data of the first predetermined type, and having a function of converting, without controls by the processing unit, data of the second predetermined type into data of the first predetermined type to be outputted through the communication interface.

2. The multifunction peripheral according to claim 1,
further comprising an operation unit to be operated to start an internet phone communication executed through the external device connected to an Internet,
wherein the conversion unit executes conversion of data from the first predetermined type to the second predetermined type and conversion of data from the second predetermined type to the first predetermined type in response to the operation unit being operated.

3. The multifunction peripheral according to claim 1,
further comprising:
a sound interface through which sound is inputted and outputted; and
a sound conversion unit configured to execute data conversion between sound data processed through the sound interface and data of the second predetermined type adapted to the phone communication function,
wherein the conversion unit converts data of the second predetermined type converted by the sound conversion unit into data of the first predetermined type and converts the external data received through the communication interface into data of the second predetermined type which the sound conversion unit is able to convert into sound data.

4. The multifunction peripheral according to claim 3,
further comprising:
a first storage unit configured to store a plurality of pieces of data of the second predetermined type respectively associated with values concerning data of the first predetermined type; and
a second storage unit configured to store a plurality of pieces of data of the first predetermined type respectively associated with values concerning data of the second predetermined type,
wherein:
in order to convert data of the second predetermined type into data of the first predetermined type, the conversion unit reads, from the second storage unit, data of the first predetermined type being associated with a value concerning data of the second predetermined type converted from the sound data by the sound data conversion unit; and
in order to convert data of the first predetermined type into data of the second predetermined type, the conversion unit reads, from the first storage unit, data of the second predetermined type being associated with a value concerning data of the first predetermined type received from the external device.

5. The multifunction peripheral according to claim 4,
wherein:
the second predetermined type of data stored in the first storage unit is defined in accordance with at least one of a modulating way and a sampling frequency concerning the phone communication function; and
the first predetermined type of data stored in the second storage unit is defined in accordance with at least one of a modulating way and a sampling frequency concerning the external data from the external device.

6. The multifunction peripheral according to claim 1,
wherein:
the plurality of functions of the multifunction peripheral includes a copying function of reading an object to create read data and recording an image corresponding to the read data on a recording medium; and
an internet phone communication is executed through an operation for converting between data of the first predetermined type and data of the second predetermined type by the conversion unit while the copying function is executed under control of the processing unit.
